(19) United States
(12) Patent Application Publication
(10) Pub. No.: US 2006/0049736 A1
(43) Pub. Date: Mar. 9, 2006

(54) Method and structure of converging electron-emission source of field-emission display

(76) Inventors: Chun-Yen Hsiao, Guanyin Township (TW); Frank Yang, Guanyin Township (TW); Kuei-Wen Cheng, Guanyin Township (TW)

Correspondence Address: Yi-Wen Tseng, 4331 Stevens Battle Lane, Fairfax, VA, 22033, US

(21) Appl. No.: 10/934,581

(22) Filed: Sep. 3, 2004

(51) Int. Cl. H01J 1/14

(52) U.S. Cl. 313/311

(57) ABSTRACT

A method and a structure for a converging-type electron-emission source of a field-emission display are disclosed. A substrate is provided, and a silver paste is used to form a first electrode layer on the substrate by the process such as thick-film photolithography screen-printing. At least one pit is formed in the first electrode layer by etching, for example. A passivation layer is formed on the first electrode layer around the pit. A second electrode layer is formed in the recess by photolithography or electrophoresis, for example. Preferably, the second electrode layer is formed with a top surface lower than a periphery of the pit, such that a converging opening of the second electrode layer is formed over the second electrode layer. The passivation layer is then removed, followed by a step of sintering process.

### BACKGROUND OF THE INVENTION

The present invention relates in general to a structure and a method for forming a converging-type electron-emission source of a field-emission display, and more particularly, to a method of forming an electron-emission source recessed from a peripheral electrode layer is formed, such that potential distribution established by the electric field of the electrode layer provides converging effect of an electron beam generated by the electron-emission source.

In the conventional bipolar or tri-polar field-emission display having a carbon nanotube as an electron-emission source (as shown in FIGS. 1 and 2), the electrons are drained from the electron-emission source to impinge the phosphor layer of the anode, so as to excite the phosphor to illuminate. The configuration of the cathode and anode often causes the electron beams diverged due to the electric field. Sometimes the electron beams may even impinge the phosphor of the neighboring anode unit to cause gamut. The image display by such display is thus seriously degraded.

To resolve the electron-beam diffusion problem of the conventional bipolar or tri-polar field-emission display, tetra-polar (as shown in FIG. 3) or penta-polar field-emission display has been proposed. The tetra- or penta-polar field-emission display has a converging electrode layer in addition to the basic components of the bi- or tri-polar field-emission display. Therefore, the electron emission generated from the cathode can be focused or converged into a concentrated beam to precisely and sufficiently impinge the phosphor of the corresponding anode unit. Thereby, gamut is prevented to appear in the image.

The converging electrode layer formed between the cathode structure and the anode structure of a tetra-polar field-emission display provides a voltage to converge the electron beam. The fabrication process of this type of tetra-polar field-emission display includes forming a converging electrode layer on a gate electrode layer by photolithography, or forming a shadow mask between the cathode and anode structures to serve as the converging electrode layer. Either type of converging electrode layer does not only increase the complexity of fabrication, but also increase the material cost.

### BRIEF SUMMARY OF THE INVENTION

It is therefore a substantial need for redesigning the cathode structure of a field-emission display without causing extra fabrication process and cost. The redesign of the cathode structure provides a converging electrode layer that does not require extra circuit control, while the fabrication process is simplified, and material cost is greatly reduced. By the redesign of the cathode structure as provided, the electron beam generated by the electron-emission source is converged and concentrated to precisely impinge the phosphor of the corresponding anode unit.

The method of forming a converging-type electron-emission source of a field-emission display as provided has the following steps. A glass substrate is provided. A first electrode layer is formed on the substrate. At least one pit is formed in the first electrode layer. A protection layer to cover the first electrode layer around the pit and expose the pit. A second electrode layer is formed in the exposed pit, wherein the second electrode layer is lower than the first electrode layer. Preferably, the first electrode layer is fabricated from silver ink and the second electrode layer is fabricated from carbon nanotube.

A cathode structure of a field-emission display is also provided to comprise a substrate, a first electrode layer and a second electrode layer. The first electrode layer is formed on the substrate and includes a plurality of pits therein. In each of the pits, a second electrode layer is formed with a height lower than that of the first electrode layer.

### BRIEF DESCRIPTION OF THE DRAWINGS

The above objects and advantages of the present invention will be become more apparent by describing in detail exemplary embodiments thereof with reference to the attached drawings in which:

FIG. 1 shows a conventional bipolar field-emission display;

FIG. 2 shows a conventional tri-polar field-emission display;

FIG. 3 shows a conventional tetra-polar field-emission display;

FIGS. 4-8 shows the fabrication process of a cathode structure of a field-emission display in one embodiment of the present invention;

FIG. 9 shows the a single cathode unit of a field-emission display provided by the present invention; and

FIG. 10 shows the emission of electrons generated by the cathode structure of the field-emission display provided by the present invention.

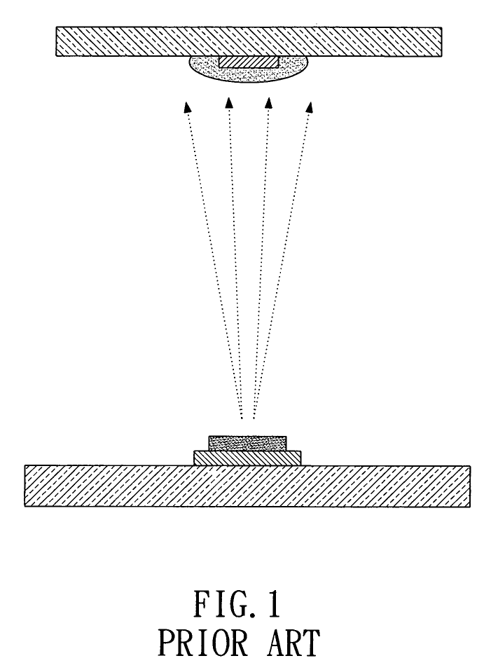

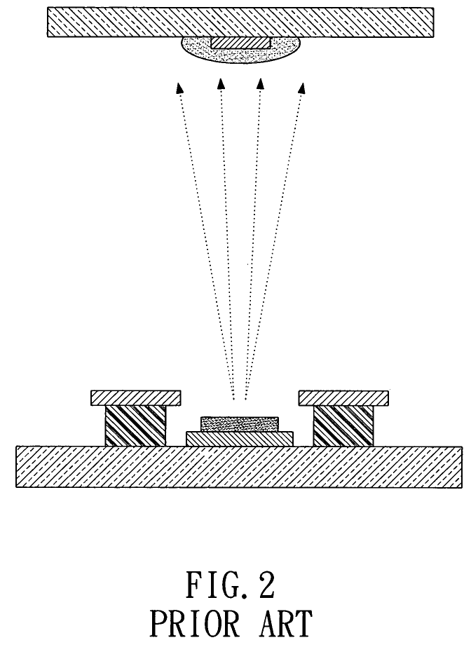

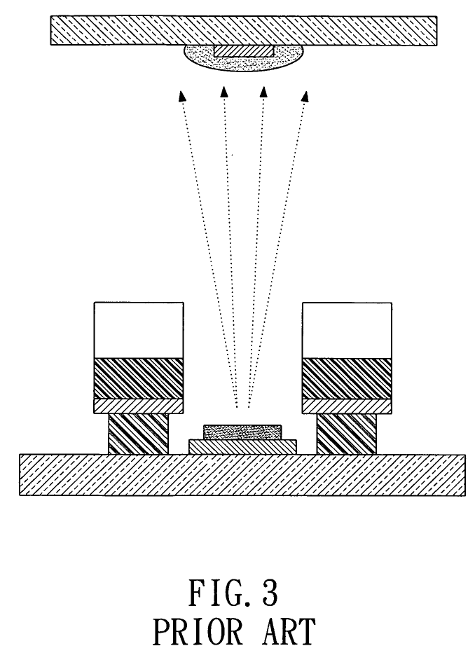

### DETAILED DESCRIPTION OF THE INVENTION

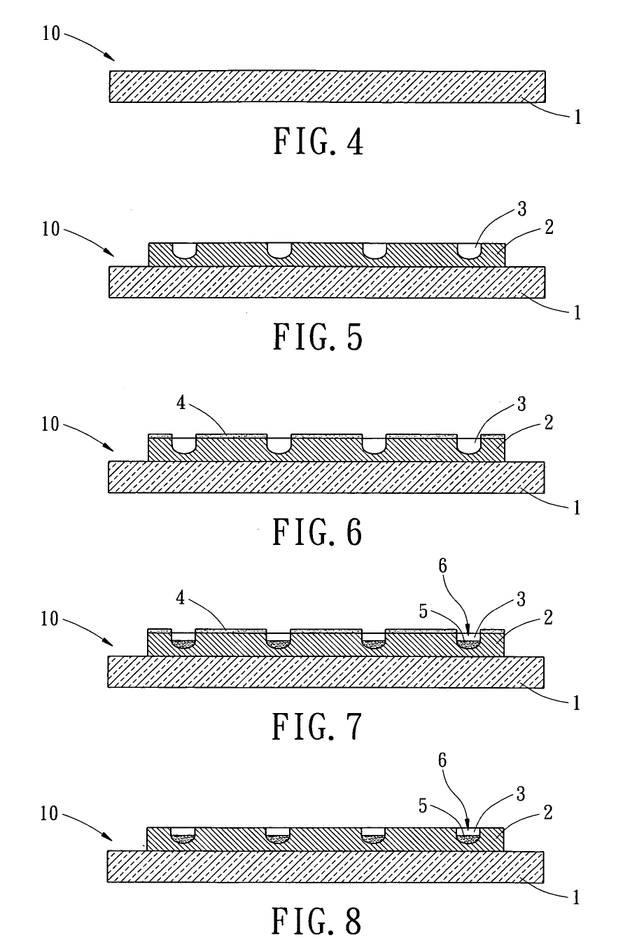

Referring to FIGS. 4-8, the fabrication process of the cathode structure of a field-emission display is illustrated. The fabricated process as provided includes a step of forming an electron-emission source recessed from a peripheral electrode layer, such that the potential distribution established by the electric field of the peripheral electrode layer provides converging effect to an electron beam generated by the electron-emission source. A carbon nanotube is preferably used as the material for forming the electron-emission source.

While fabricating the cathode structure 10 of the field-emission display, a glass substrate 1 provided. A first electrode layer 2 is formed on the substrate 1 from photoresist-type silver ink. The method for forming the first electrode layer 2 includes thick-film photolithography, and the thickness of the first electron layer 2 is about 40 microns to 50 microns, for example.

A photolithography and etching step is the performed on the first electrode layer 2 to form at least a pit 3 therein. The depth of the pit 3 is preferably 20 microns to 40 microns, for example.

When the pit 3 is formed in the first electrode layer 2, a photoresist protection layer 4 is formed to cover the first electrode layer 2 around the pit 3 and expose the pit 3. The photoresist protection layer 4 prevent the material for forming a electron-emission layer from being attached to the first electrode layer 3.

Carbon nanotube is used as the source material for forming a second electrode layer 5 in the pit 3 by coating and photolithography or electrophoresis. The thickness of the second electrode layer 5 is about 1 micron to 5 microns. The second electrode layer 5 serves as the electron source of the cathode structure 10. As the pit 3 recessed from the peripheral first electrode layer 2 by a depth of about 20 microns to 40 microns, while the second electrode layer 5 has a thickness of about 1 micron to 5 microns only, the second electrode layer 5 is lower than the peripheral first electrode layer 2. The geometry and potential of the first electrode layer 2 around the second electrode layer 5 thus forms a converging opening 6 for the electrons generated from the second electrode layer 5. The converging effect can be optimized by adjusting the interior diameter of the converging opening 6.

When the second electrode layer 5 is formed, an etching or polishing process is performed to remove the photoresist protection layer 4. A sintering process is then performed.

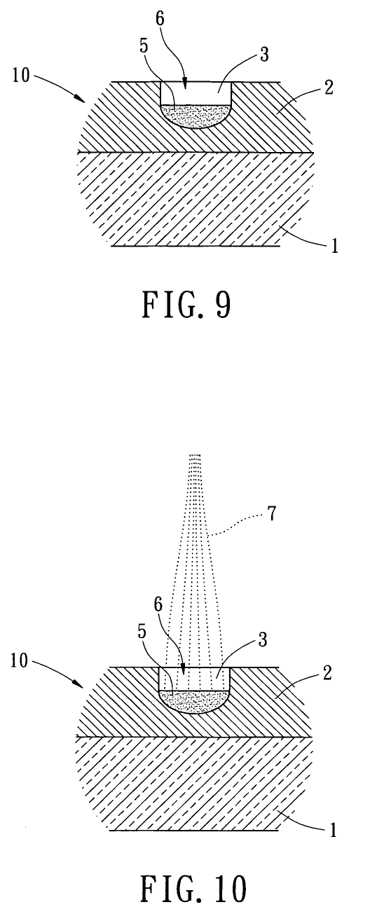

FIGS. 9 and 10 show the structure of a single cathode unit and the electron-beam emitted from the cathode unit. The cathode unit includes the first electrode layer 2 formed on the substrate 1. The first electrode layer 2 has a pit 3 therein. The second electrode layer 5 is formed within the pit 3. As shown in FIG. 9, the top surface of the second electrode layer 5 is lower than that of the first electrode layer 2. Therefore, a converging opening 6 is formed over the second electrode layer 5.

When a voltage is applied to the field-emission display 10 to excite an electron beam 7 from the second electrode layer 5, the converging opening 5 formed by the first electrode layer 2 causes the electron beam 7 to be concentrated, such that the electron beam 7 can precisely impinge the phosphor layer of the corresponding anode unit without causing gamut.

Therefore, the electron-emission source of the field-emission display has at least the following advantages:
(1) Electrons drained form the electron source of the cathode structure are converged by the configuration of and electric field induced by the first electrode layer;
(2) The concentration effect is advantageous for providing uniform distribution of the electron beam; and
(3) Low-cost thick-film process can be used for forming the converging-type electron emission source, such that the cost for fabricating the field-emission display can be reduced.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A method of forming a converging-type electron-emission source of a field-emission display, comprising:
providing a substrate;
forming a first electrode layer on the substrate;
forming at least one pit in the first electrode layer;
forming a protection layer to cover the first electrode layer around the pit and expose the pit; and
forming a second electrode layer in the exposed pit, wherein the second electrode layer is lower than the first electrode layer.

2. The method of claim 1, wherein the step of providing a substrate includes a step of providing a glass substrate.

3. The method of claim 1, wherein the step of forming the first electrode layer includes using silver ink to form the first electrode layer.

4. The method of claim 3, wherein the step of forming the first electrode layer includes forming the first electrode layer with a thickness of about 40 to 50 microns.

5. The method of claim 1, wherein the step of forming the first electrode layer includes a thick-film process.

6. The method of claim 1, wherein the step of forming the pit includes forming the pit with a thickness of about 20 to 40 microns.

7. The method of claim 1, wherein the second electrode layer is fabricated from carbon nanotube.

8. The method of claim 1, wherein the step of forming the second electrode layer includes forming the second electrode layer with a thickness of about 1 to 5 microns.

9. The method of claim 1, further comprising a step of varying the dimension of the pit, so as to adjust converging effect of an electron beam generated by the second electrode layer.

10. The method of claim 1, wherein the step of forming the second electrode layer includes performing coating and photolithography or performing electrophoresis.

11. A method of forming a cathode structure for a field-emission display, comprising:
providing a substrate;
forming a first electrode layer on the substrate;
forming a plurality of pits in the first electrode layer;
forming a second electrode layer in the pits, wherein the second electrode layer is recessed from the first electrode layer, such that a potential distribution is establish to provide converging effect upon an electron beam generated from the second electrode layer.

12. The method of claim 11, wherein the first electrode layer is formed by a thick-film process.

13. The method of claim 11, wherein the first electrode layer is formed of silver ink.

14. The method of claim 11, wherein the second electrode layer is formed of carbon nanotube.

15. The method of claim 11, wherein the first electrode layer has a thickness of about 40 microns to about 50 microns.

16. The method of claim 11, wherein each of the pits has a depth of about 20 microns to about 40 microns.

17. The method of claim 11, wherein the second electrode layer has a thickness of about 1 micron to 5 microns.

18. The method of claim 11, further comprising the step of:
forming a photoresist layer to cover the first electrode layer while exposing the pits before the second electrode layer is formed;
removing the photoresist layer after the second electrode layer is formed.

19. A cathode structure of a field-emission display, comprising a first electrode layer and an electron-emission source layer formed on a recessed portion of the first electrode layer, wherein the electron-emission source layer has a thickness smaller than a depth of the recessed portion, such that a converging opening is formed over the electron-emission source layer.

20. The cathode structure of claim 19, wherein the electron-emission source layer is fabricated from carbon nanotube layer.
